(19) United States
(12) Patent Application Publication
(10) Pub. No.: US 2024/0014898 A1
(43) Pub. Date: Jan. 11, 2024

(54) PROVISION DETERMINATION SYSTEM, PROVISION DETERMINATION APPARATUS, AND PROVISION DETERMINATION METHOD

(71) Applicant: NEC Corporation, Tokyo (JP)

(72) Inventors: Koya TAKATA, Tokyo (JP); Atsushi KAMOI, Tokyo (JP); Hisashi MIZUMOTO, Tokyo (JP); Masaki AIZONO, Tokyo (JP)

(73) Assignee: NEC Corporation, Tokyo (JP)

(21) Appl. No.: 18/218,531

(22) Filed: Jul. 5, 2023

(30) Foreign Application Priority Data
Jul. 8, 2022 (JP) 2022-110745

(51) Int. Cl. H04B 10/112

(52) U.S. Cl. CPC H04B 10/1123

(57) ABSTRACT

A provision determination system (100) includes at least one processor (1301), the at least one processor (1301) executing: an obtaining process (S201) of obtaining information indicating a load of communication of a first free-space optical communication apparatus connected to a free-space optical communication network; and a determining process (S202) of making a determination on necessity for provision of a second free-space optical communication apparatus connected to the free-space optical communication network, the determination being made in accordance with the information indicating the load of the communication.

This Nonprovisional application claims priority under 35 U.S.C. § 119 on Patent Application No. 2022-110745 filed in Japan on Jul. 8, 2022, the entire contents of which are hereby incorporated by reference.

### TECHNICAL FIELD

The present invention relates to a provision determination system, a provision determination apparatus, and a provision determination method.

### BACKGROUND ART

Research is being carried out on free-space optical communication according to which communication is carried out by emitting light in a space.

Patent Literature 1 discloses a free-space optical transmission apparatus that emits light in a space for bidirectional transmission of data and temporarily stores communication log continuously at each fixed interval of time.

Patent Literature 2 discloses a communication apparatus including a radio communication means that receives/transmits a radio signal and an optical communication means that transmits/receives spatial light as communication light, the communication apparatus communicating with a communication apparatus through communication light, the communication apparatuses constituting a radio communication network.

### CITATION LIST

### Patent Literature

[Patent Literature 1]
Japanese Patent Application Publication. Tokukai, No. 2009-71368

[Patent Literature 2]
International Publication, No. WO 2017/169913

### SUMMARY OF INVENTION

### Technical Problem

Incidentally, in a case where communication is carried out with use of free-space optical communication apparatuses, the number of free-space optical communication apparatuses needs to be changed depending on the load of the communication. For example, in a case where a certain number of free-space optical communication apparatuses are provided in a place and communication traffic required in the space cannot be dealt with by the certain number of free-space optical communication apparatuses, there is a possibility that the number of free-space optical communication apparatuses needs to be increased. However, Patent Literatures 1 and 2 do not disclose at all a technique for making a determination on provision of a free-space optical communication apparatus.

An example object of the present invention is to provide a provision determination system, a provision determination apparatus, and a provision determination method each of which is suitable for making a determination on provision of a free-space optical communication apparatus.

### Solution to Problem

A provision determination system in accordance with an example aspect of the present invention includes at least one processor, the at least one processor executing: an obtaining process of obtaining information indicating a load of communication of a first free-space optical communication apparatus connected to a free-space optical communication network; and a determining process of making a determination on necessity for provision of a second free-space optical communication apparatus connected to the free-space optical communication network, the determination being made in accordance with the information indicating the load of the communication.

A provision determination apparatus in accordance with an example aspect of the present invention includes at least one processor, the at least one processor executing: an obtaining process of obtaining information indicating a load of communication of a first free-space optical communication apparatus connected to a free-space optical communication network; and a determining process of making a determination on necessity for provision of a second free-space optical communication apparatus connected to the free-space optical communication network, the determination being made in accordance with the information indicating the load of the communication.

A provision determination method in accordance with an example aspect of the present invention includes the steps of: obtaining information indicating a load of communication of a first free-space optical communication apparatus connected to a free-space optical communication network; and, in accordance with the information indicating the load of the communication, making a determination on necessity for provision of a second free-space optical communication apparatus connected to the free-space optical communication network.

### Advantageous Effects of Invention

In accordance with the present invention, it is possible to make a suitable determination on provision of a free-space optical communication apparatus.

### BRIEF DESCRIPTION OF DRAWINGS

FIG. 1 is a block diagram illustrating an example of a configuration of a provision determination system in accordance with a first example embodiment.

FIG. 2 is a flowchart illustrating an example of operation of the provision determination system in accordance with the first example embodiment.

FIG. 3 is a block diagram illustrating an example of a configuration of a provision determination apparatus in accordance with the first example embodiment.

FIG. 4 is a block diagram illustrating an example of a configuration of a provision determination system in accordance with a second example embodiment.

FIG. 5 is a block diagram illustrating an example of a configuration of a provision determination system in accordance with a third example embodiment.

FIG. 6 is a block diagram illustrating an example of a configuration of a provision determination system in accordance with a fourth example embodiment.

FIG. 7 is a flowchart illustrating an example of operation of the provision determination system in accordance with the fourth example embodiment.

FIG. 8 is a view illustrating an example of a free-space optical communication network.

FIG. 9A is a block diagram illustrating an example of a configuration of a provision determination apparatus in accordance with the fourth example embodiment.

FIG. 9B is a block diagram illustrating another example of the configuration of the provision determination apparatus in accordance with the fourth example embodiment.

FIG. 10 is a block diagram illustrating a configuration of a provision determination system in accordance with a fifth example embodiment.

FIG. 11 is a view illustrating an example of a map generated by a map generating means.

FIG. 12A is a block diagram illustrating an example of a provision determination apparatus in accordance with the fifth example embodiment.

FIG. 12B is a block diagram illustrating an example of the provision determination apparatus in accordance with the fifth example embodiment.

FIG. 13 is a view illustrating an outline of a hardware of a computer in accordance with an embodiment.

### DESCRIPTION OF EMBODIMENTS

### First Example Embodiment

(Setting Determination System)

The following description will discuss a provision determination system 100 in accordance with a first example embodiment of the present invention with reference to the drawings. The provision determination system 100 is a system that makes a determination on provision of a free-space optical communication apparatus.

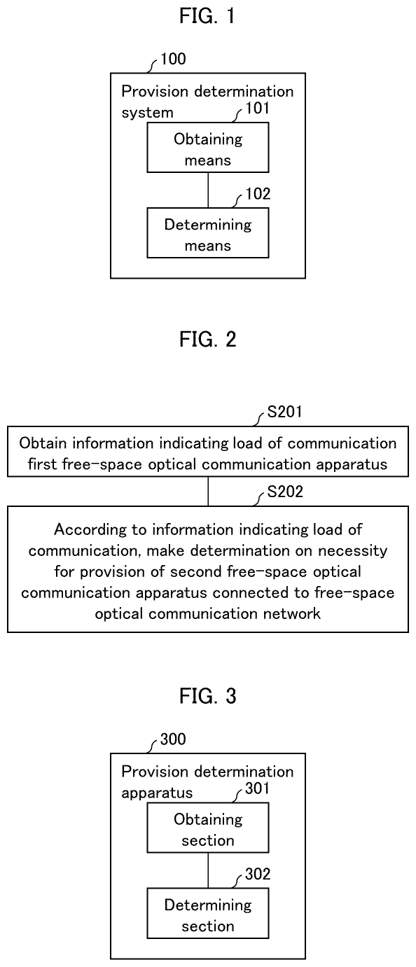

FIG. 1 is a functional block diagram illustrating an example of a configuration of the provision determination system 100 in accordance with the first example embodiment of the present invention. In FIG. 1, each block indicates a configuration in units of function. Thus, the blocks in FIG. 1 may be implemented in a single apparatus or a plurality of apparatuses. Alternatively, some of or all of the blocks may be implemented as functions in a cloud or the like. The provision determination system 100 includes an obtaining means 101 and a determining means 102.

The obtaining means 101 obtains information indicating a load of communication of a first free-space optical communication apparatus connected to a free-space optical communication network. The free-space optical communication refers to communication involving use of light propagating in a space. Here, examples of the light can include a millimeter wave, a sub-millimeter wave, infrared light, visible light, and ultraviolet light. The free-space optical communication network means a communication network constituted by free-space optical communication apparatuses. Each of the free-space optical communication apparatuses constituting the communication network may communicate with another free-space optical communication apparatus in a one-to-one relation. Alternatively, the free-space optical communication apparatuses constituting the communication network may be connected to each other such that the free-space optical communication apparatuses communicate with each other in a many-to-many relation. Here, the connection means a state where light can be transmitted/received through the free-space optical communication network. That is, the first free-space optical communication apparatus is in a state where the first free-space optical communication apparatus can transmit/receive light to/from another free-space optical communication apparatus (hereinafter, referred to as a third free-space optical communication apparatus) constituting the free-space optical communication network. The load of the communication means a load, caused by communication, on the free-space optical communication apparatuses and the network thereof. Examples of the load of the communication include utilization of a CPU mounted in each free-space optical communication apparatus, communication traffic, and the number of channels used by the free-space optical communication apparatus(es). Further, in a case where the free-space optical communication apparatus carries out radio communication with a terminal(s), the number of terminals connected thereto may be regarded as the load of the communication, for example. Examples of the information indicating the load of the communication of the first free-space optical communication apparatus includes communication log of the first free-space optical communication apparatus.

In accordance with the information indicating the load of the communication, the determining means 102 makes a determination on necessity for provision of a second free-space optical communication apparatus connected to the free-space optical communication network. The second free-space optical communication apparatus may have the same configuration as the first free-space optical communication apparatus. Alternatively, the second free-space optical communication apparatus may be a different type of free-space optical communication apparatus from the first free-space optical communication apparatus or may be different in configuration from the first free-space optical communication apparatus. The second free-space optical communication apparatus may be provided depending on a result of determination made by the determining means, and may be connected to the free-space optical communication network. The second free-space optical communication apparatus may be provided depending on a result of determination made by the determining means and judgment of an administrator of the free-space optical communication network, and may be connected to the free-space optical communication network.

The following description will discuss, with reference to the drawings, operation of the provision determination system in accordance with the first example embodiment. FIG. 2 is a flowchart illustrating an example of operation of the provision determination system 100.

The obtaining means 101 obtains information indicating a load of communication of the first free-space optical communication apparatus (S201). For example, the obtaining means 101 may obtain, from the first free-space optical communication apparatus, the information indicating the load relating to the communication of the first free-space optical communication apparatus. For another example, the obtaining means 101 may obtain, from an apparatus accumulating information relating to the apparatuses constituting the free-space optical communication network, the information indicating the load relating to the communication of the first free-space optical communication apparatus.

In accordance with the information indicating the load of the communication, the determining means 102 makes a determination on necessity for provision of the second free-space optical communication apparatus connected to the free-space optical communication network (S202). For example, the determining means 102 compares the obtained information indicating the load of the communication of the first free-space optical communication apparatus with a preset threshold; then, if the load of the communication of the first free-space optical communication apparatus is not less than the threshold, the determining means 102 may determine that it is necessary to provide the second free-space optical communication apparatus. For another example, the determining means 102 may calculates a statistical value of the load of the communication of the first free-space optical communication apparatus in accordance with the obtained information indicating the load of the communication of the first free-space optical communication apparatus, and compare the statistical value thus calculated with a preset threshold; then, if the load of the communication of the first free-space optical communication apparatus is not less than the threshold, the determining means 102 may determine that it is necessary to provide the second free-space optical communication apparatus.

(Provision Determination Apparatus)

FIG. 3 is a block diagram illustrating an example of a configuration of a provision determination apparatus 300 in accordance with the first example embodiment of the present invention. An obtaining section 301 has the same function as the obtaining means 101. The obtaining section 301 obtains information indicating a load of communication of the first free-space optical communication apparatus connected to the free-space optical communication network. A determining section 302 has the same function as the determining means 102. In accordance with the information indicating the load of the communication, the determining section 302 makes a determination on necessity for provision of the second free-space optical communication apparatus connected to the free-space optical communication network. The obtaining section 301 and the determining section 302 may be a computer apparatus including a processor executing a program stored in a memory to execute a process. The obtaining section 301 and the determining section 302 may be included in the first free-space optical communication apparatus.

For example, the obtaining section 301 may be a single computer apparatus or a single server apparatus. Alternatively, the obtaining section 301 may be a computer apparatus group including a plurality of computer apparatuses which operate in a related manner or a server apparatus group including a plurality of server apparatuses which operate in a related manner. The determining section 302 may also have the same configuration as the obtaining section 301. With the provision determination apparatus 300, it is possible to attain the same effect as that given by the provision determination system 100.

Each of the provision determination system, the provision determination method, and the provision determination apparatus in accordance with the first example embodiment makes a determination on necessity for provision of the second free-space optical communication apparatus connected to the free-space optical communication network. Making a determination on necessity for provision of the second free-space optical communication apparatus enables, e.g., an administrator of the free-space optical communication network to make a suitable determination on provision of the free-space optical communication apparatus. For example, according to the determination that provision of the second free-space optical communication apparatus is necessary, the administrator of the free-space optical communication network can provide the second free-space optical communication apparatus in order to deal with a case where a communication quality required by a user may possibly not be achieved with the current number of free-space optical communication apparatuses or a case where the communication quality required by the user may possibly not be achieved with the current number of free-space optical communication apparatuses in the future.

In a case where the second free-space optical communication apparatus is provided, the load of the communication of the first free-space optical communication apparatus is reduced. By distributing (decentralizing) the communication load to the first free-space optical communication apparatus and the second free-space optical communication apparatus, it is possible to reduce utilization of a CPU in the first free-space optical communication apparatus, for example.

In a case where the number of used channels exceeds a value preset for the first free-space optical communication apparatus, there is a possibility that the first free-space optical communication apparatus may not accept new connection of an apparatus. Further, in a case where the number of used channels exceeds the value preset for the first free-space optical communication apparatus, a single channel used for communication may be divided into a plurality of channels so that the plurality of channels are used for communication with a plurality of communication target apparatuses, for example. Dividing the single channel decreases a frequency band usable for communication, thereby reducing a bit rate. In order to avoid this, the communication load is distributed to the first free-space optical communication apparatus and the second free-space optical communication apparatus, which can increase the number of free-space optical communication apparatuses connected to the first free-space optical communication apparatus, for example. Further, distributing the communication load to the first free-space optical communication apparatus and the second free-space optical communication apparatus can increase a frequency band allocated to the communication targets, thereby improving the bit rate, for example.

Further, by distributing the communication load to the first free-space optical communication apparatus and the second free-space optical communication apparatus, it is possible to prevent reduction in the bit rate, for example. This is because that, in a case where communication traffic between the first and third free-space optical communication apparatuses increases, a bit rate in communication between the first and third free-space optical communication apparatuses decreases.

Further, in a case where the first and second free-space optical communication apparatuses carry out radio communication with a terminal(s), providing the second free-space optical communication apparatus can increase the number of terminals connectable to the free-space optical communication apparatuses, for example. Providing the second free-space optical communication apparatus can increase the number of terminals that can use the free-space optical communication apparatuses.

### Second Example Embodiment

A provision determination system 400 in accordance with a second example embodiment differs from the provision determination system 100 in accordance with the first example embodiment in that the provision determination system 400 further includes a setting means 403. Note that configurations identical to those of the first example embodiment are given identical reference signs, and a description thereof will be omitted.

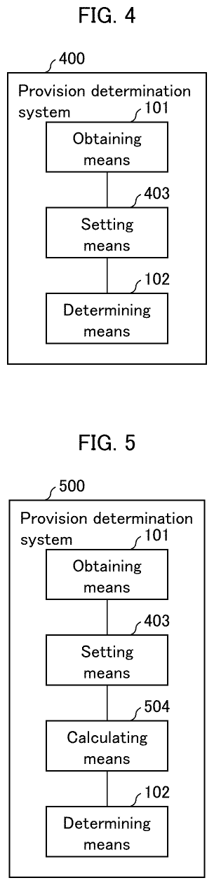

FIG. 4 is a block diagram illustrating an example of a configuration of the provision determination system 400 in accordance with the second example embodiment of the present invention. The setting means 403 sets a threshold in accordance with performance of a first free-space optical communication apparatus. The performance of the first free-space optical communication apparatus refers to, for example, performance of a CPU mounted in the first free-space optical communication apparatus, the number of channels set for the first free-space optical communication apparatus, and/or a capacity of a transmission path of a communication method of the first free-space optical communication apparatus.

The setting means 403 sets, as the threshold, a given percentage of the performance of the first free-space optical communication apparatus, for example. The setting means 403 may set, as the threshold, 90% of the performance of the CPU mounted in the first free-space optical communication apparatus, for example. Alternatively, the setting means 403 may set, as the threshold, 85% of the number of channels set for the first free-space optical communication apparatus. Further alternatively, the setting means 403 may set, as the threshold, 70% of the capacity of the transmission path of the communication method of the first free-space optical communication apparatus. Still further alternatively, the setting means 403 may learn a load of the first free-space optical communication apparatus observed when the bit rate was reduced in the past, and may set, as the threshold, the load of the first free-space optical communication apparatus observed when the bit rate was reduced. Yet further alternatively, the setting means 403 may refer to a threshold of a free-space optical communication apparatus having the same performance as the first free-space optical communication apparatus, and may set it as the threshold for the first free-space optical communication apparatus. The information indicating the performance of the first free-space optical communication apparatus 100 may be retained in the provision determination system 400. The information indicating the performance of the first free-space optical communication apparatus 100 may be obtained by the obtaining means 101 from the first free-space optical communication apparatus. Further, the obtaining means 101 may obtain information relating to an apparatus model from the first free-space optical communication apparatus, and the setting means 403 may specify the performance of the first free-space optical communication apparatus on the basis of information indicating correspondence between the apparatus model and the performance. With the configuration in which the setting means 403 specifies the performance of the first free-space optical communication apparatus on the basis of the information indicating the correspondence between the apparatus model and the performance, the provision determination system 400 can deal with even a case where free-space optical communication apparatuses constituting the free-space optical communication network have respective difference performances.

The determining means 102 makes a determination on necessity for provision of the second free-space optical communication apparatus on the basis of the information indicating the load of the communication and the threshold. For example, in a case where the information indicating the load of the communication includes information indicating that a load of a first communication apparatus exceeds the threshold, the determining means may determine that it is necessary to provide the second free-space optical communication apparatus. For another example, in a case where a statistical value of the load of the first communication apparatus calculated in accordance with the information indicating the load of the communication exceeds the threshold, the determining means may determine that it is necessary to provide the second free-space optical communication apparatus.

By setting the threshold in accordance with the performance of the first free-space optical communication apparatus, the provision determination system in accordance with the second example embodiment can make a more suitable determination on provision of the second free-space optical communication apparatus. For example, in a case where free-space optical communication apparatuses having different performances are provided mixedly in the free-space optical communication network, the setting means 403 may respectively set thresholds for the free-space optical communication apparatuses. Consequently, it is possible to make a determination on necessity for provision of the second free-space optical communication apparatus in accordance with processing capacities of the free-space optical communication apparatuses.

The foregoing description of the second example embodiment has discussed the provision determination system 400. However, the provision determination system 400 in accordance with the second example embodiment may be mounted in a single apparatus so as to be provided as a provision determination apparatus. The provision determination apparatus in accordance with the second example embodiment includes, in addition to the features of the provision determination apparatus in accordance with the first example embodiment, a setting section that sets the threshold in accordance with the performance of the first free-space optical communication apparatus, wherein the determining section makes a determination on necessity for provision of the second free-space optical communication apparatus in accordance with the information indicating the communication load and the threshold.

Further, a provision determination method achieved by adding the setting method of the setting means 403 to the provision determination method in accordance with the first example embodiment is also within the scope of the disclosure of the second example embodiment. The provision determination method in accordance with the second example embodiment includes, in addition to the features of the provision determination method in accordance with the first example embodiment, the steps of: setting a threshold in accordance with the performance of the first free-space optical communication apparatus, wherein, in the step of determining, the determination on necessity for provision of the second free-space optical communication apparatus is made in accordance with the information indicating the communication load and the threshold.

### Third Example Embodiment

A provision determination system 500 in accordance with a third example embodiment differs from the provision determination system 400 in accordance with the second example embodiment in that the provision determination system 500 further includes a calculating means 504. Note that configurations identical to those of the first and second example embodiments are given identical reference signs, and a description thereof will be omitted.

FIG. 5 is a block diagram illustrating an example of a configuration of the provision determination system 500 in accordance with the third example embodiment of the present invention. The calculating means 504 calculates indices of loads in respective time slots in accordance with information indicating a load of communication of a first free-space optical communication apparatus. Examples of the index of the load may include an average value, a median value, a minimum value, and a maximum value of load. For example, the calculating means 504 may obtain information indicating a load of communication of the first free-space optical communication apparatus, the load corresponding to a given period of time. Then, the calculating means 504 may calculate indices of loads of morning, noon, and night. The time slots are not limited to morning, noon, and night. Alternatively, the time slots may be given time intervals, such as a period from 10 a.m. to 12 p.m. and a period from 12 p.m. to 2 p.m.

In accordance with the indices of the loads of the respective time slots and a threshold, the determining means 102 makes a determination on necessity for provision of a second free-space optical communication apparatus. For example, in a case where an index of a load of a certain time slot of the first free-space optical communication apparatus exceeds the threshold, the determining means may determine that it is necessary to provide the second free-space optical communication apparatus.

Note that the setting means 403 may obtain an average value and a maximum value of the loads of the communication in the respective time slots, the average value and the maximum value being calculated by the calculating means 504. Then, in accordance with a difference between the average value and the maximum value in the same time slot, the setting means 403 may set the threshold. For example, in a case where the difference between the average value and the maximum value of the loads of the communication in the respective time slots calculated by the calculating means 504 is higher than a given value, the setting means 403 lowers the currently set threshold. This is because that, if the difference between the maximum value and the average value of the loads of the communication is large, a communication status in a place where the first free-space optical communication apparatus is provided is highly likely to vary in a short period of time.

The provision determination system 500 in accordance with the third example embodiment makes a determination on necessity for provision of the second free-space optical communication apparatus depending on the indices of the loads in the respective time slots and the threshold. For example, assume a case where an index of a load per day is calculated. In this case, if the load is low in the morning and the load is high at night, an average thereof may be obtained as the index of the load. The provision determination system 500 in accordance with the third example embodiment makes a determination on necessity for provision of the second free-space optical communication apparatus in accordance with the indices of the loads in the respective time slots and the threshold. This makes it possible to determine that it is necessary to provide the second free-space optical communication apparatus also when the communication load becomes high only in a certain time slot, e.g., during rush hours, for example.

The foregoing description of the third example embodiment has discussed the provision determination system 500. However, the provision determination system 500 in accordance with the third example embodiment may be mounted in a single apparatus so as to be provided as a provision determination apparatus. The provision determination apparatus in accordance with the third example embodiment includes, in addition to the features of the provision determination apparatus in accordance with the second example embodiment, the calculating section that calculates indices of loads in respective time slots in accordance with the information indicating the load of the communication of the first free-space optical communication apparatus, wherein the determining section makes the determination on the necessity for provision of the second free-space optical communication apparatus depending on the indices of the loads in the respective time slots and the threshold.

Further, a provision determination method achieved by adding the calculating method of the calculating means 504 to the provision determination method in accordance with the second example embodiment is also within the scope of the disclosure of the third example embodiment. The provision determination method in accordance with the third example embodiment includes, in addition to the features of the provision determination method in accordance with the second example embodiment, the steps of: calculating indices of loads in respective time slots in accordance with the information indicating the load of the communication of the first free-space optical communication apparatus, wherein, in the step of determining, the determination on the necessity for provision of the second free-space optical communication apparatus is made in accordance with the indices of the loads in the respective time slots and the threshold. Note that the step of calculating the indices of the loads in the respective time slots in accordance with the information indicating the load of the communication of the first free-space optical communication apparatus may precede the step of setting the threshold in accordance with the performance of the first free-space optical communication apparatus, or vice versa.

### Fourth Example Embodiment

A provision determination system 600 in accordance with a fourth example embodiment differs from the provision determination system 100 in accordance with the first example embodiment in that the provision determination system 600 further includes a specifying means 605. Note that configurations identical to those of the first example embodiment are given identical reference signs, and a description thereof will be omitted. The provision determination system 600 in accordance with the fourth example embodiment may also include the setting means 403 and the calculating means 504 explained in the second example embodiment and the third example embodiment.

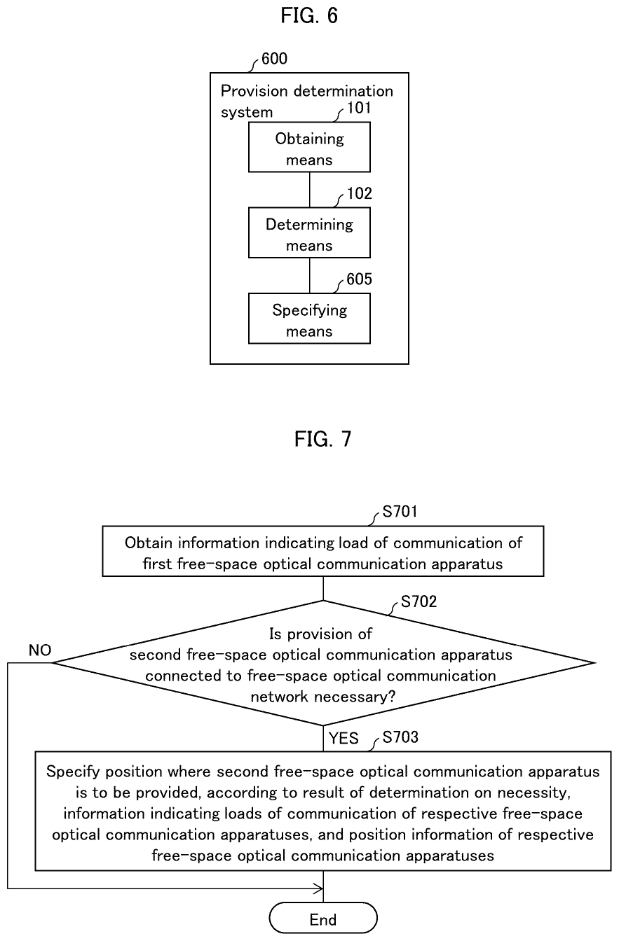

FIG. 6 is a block diagram illustrating an example of a configuration of the provision determination system 600 in accordance with the fourth example embodiment of the present invention. The specifying means 605 specifies a position where the second free-space optical communication apparatus is to be provided, in accordance with (i) a result of the determination on the necessity, (ii) the pieces of information indicating the loads of the communication of a respective plurality of free-space optical communication apparatuses including the first free-space optical communication apparatus, and (iii) pieces of position information of the respective plurality of free-space optical communication apparatuses. Here, the position information may be, e.g., information indicating a latitude and a longitude or information indicating a relative position. The information indicating the relative position is position information described focusing on a certain position or a certain building. The information indicating the relative position may be, e.g., information indicating that a free-space optical communication apparatuses is positioned in a direction at 30 degrees with respect to the first free-space optical communication apparatus and in a direction at 40 degrees with respect to the third free-space optical communication apparatus or information indicating that a free-space optical communication apparatuses is positioned in a direction at 30 degrees with respect to the first free-space optical communication apparatus and is away from the first free-space optical communication apparatus by 5 m. Note that the numerical values are indicated just as an example, and by no means limit the present invention.

The following description will discuss, with reference to the drawings, operation of the provision determination system 600 in accordance with the fourth example embodiment. FIG. 7 is a flowchart illustrating an example of operation of the provision determination system 600 in accordance with the fourth example embodiment.

The obtaining means 101 obtains the information indicating the load of the communication of the first free-space optical communication apparatus (S701). In the fourth example embodiment, the obtaining means 101 may obtain pieces of information indicating loads of communication of a respective plurality of free-space optical communication apparatuses. Further, the obtaining means 101 may obtain pieces of position information of the respective plurality of free-space optical communication apparatuses.

In accordance with the information indicating the load of the communication of the first free-space optical communication apparatus, the determining means 102 makes a determination on necessity for provision of the second free-space optical communication apparatus connected to the free-space optical communication network (S702). In the fourth example embodiment, the determining means 102 may make a determination on necessity for provision of the second free-space optical communication apparatus for each of the plurality of free-space optical communication apparatuses, the determination being made in accordance with the pieces of information indicating the loads of the communication of the respective plurality of free-space optical communication apparatuses.

The specifying means 605 specifies a position where the second free-space optical communication apparatus is to be provided, the specifying being carried out in accordance with (i) a result of the determination on the necessity, (ii) the pieces of information indicating the loads of the communication of the respective plurality of free-space optical communication apparatuses including the first free-space optical communication apparatus, and (iii) the pieces of position information of the respective plurality of free-space optical communication apparatuses (S703). Specifically, in a case where it is determined that the second free-space optical communication apparatus is necessary, the specifying means 605 specifies the position where the second free-space optical communication apparatus is to be provided, the specifying being carried out in accordance with (i) the pieces of information indicating the loads of the communication of the respective plurality of free-space optical communication apparatuses including the first free-space optical communication apparatus and (ii) the pieces of position information of the respective plurality of free-space optical communication apparatuses. The pieces of information indicating the loads of the communication of the respective plurality of free-space optical communication apparatuses and the pieces of position information of the respective plurality of free-space optical communication apparatuses may be retained by the specifying means 605. Further, the pieces of information indicating the loads of the communication of the respective plurality of free-space optical communication apparatuses and the pieces of position information of the respective plurality of free-space optical communication apparatuses may be stored in a memory included in the provision determination system 600.

[When Provision of Second Free-Space Optical Communication Apparatus is Determined to be Necessary Based on Load Relating to the Number of Channels]

For example, in a case where provision of the second free-space optical communication apparatus is determined to be necessary in accordance with a load relating to the number of channels of the first free-space optical communication apparatus (e.g., in a case where the load relating to the number of channels of the first free-space optical communication apparatus exceeds the threshold), the specifying means 605 may specify, as the position where the second free-space optical communication apparatus is to be provided, a space surrounding the first free-space optical communication apparatus. By providing the second free-space optical communication apparatus in the space surrounding the first free-space optical communication apparatus, it is possible to share part of or the whole of the free-space optical communication of the first free-space optical communication apparatus with the second free-space optical communication apparatus. Here, examples of the space surrounding the first free-space optical communication apparatus include an upper part of an electric pole to which the first free-space optical communication apparatus is provided, a lower part of the electric pole, and a place which is in a building including a place where the first free-space optical communication apparatus is provided but is different from the place of the first free-space optical communication apparatus. Hereinafter, in the fourth example embodiment, the case where provision of the second free-space optical communication apparatus is determined to be necessary in accordance with a specific load may also be referred to as a case where the specific load is high.

[When Provision of Second Free-Space Optical Communication Apparatus is Determined to be Necessary Based on Load Relating to Communication Traffic in Single Segment]

For example, in a case where a load relating to communication traffic in a single segment is high, the specifying means 605 may specify, as the position where the second free-space optical communication apparatus is to be provided, a space surrounding a free-space optical communication apparatus forming the segment. Here, the “single segment” refers to a segment in which a certain free-space optical communication apparatus is connected to another free-space optical communication apparatus. For example, in a case where a load relating to communication traffic relating to communication traffic between the first free-space optical communication apparatus and the third free-space optical communication apparatus is high, the specifying means 605 may specify, as the position where the second free-space optical communication apparatus is to be provided, a space surrounding the first free-space optical communication apparatus or a space surrounding the third free-space optical communication apparatus. By providing the second free-space optical communication apparatus in the place surrounding the first free-space optical communication apparatus or the place surrounding the third free-space optical communication apparatus, it is possible to distribute communication between the first and third free-space optical communication apparatuses to the first and second free-space optical communication apparatuses or to the second and third free-space optical communication apparatuses. The operation of the specifying means 605 is not limited to the above-described example. Alternatively, for example, in a case where a load relating to communication traffic between the first and third free-space optical communication apparatuses is high, the specifying means 605 may specify the position where the second free-space optical communication apparatus is to be provided so that communication between the first and third free-space optical communication apparatuses is decentralized.

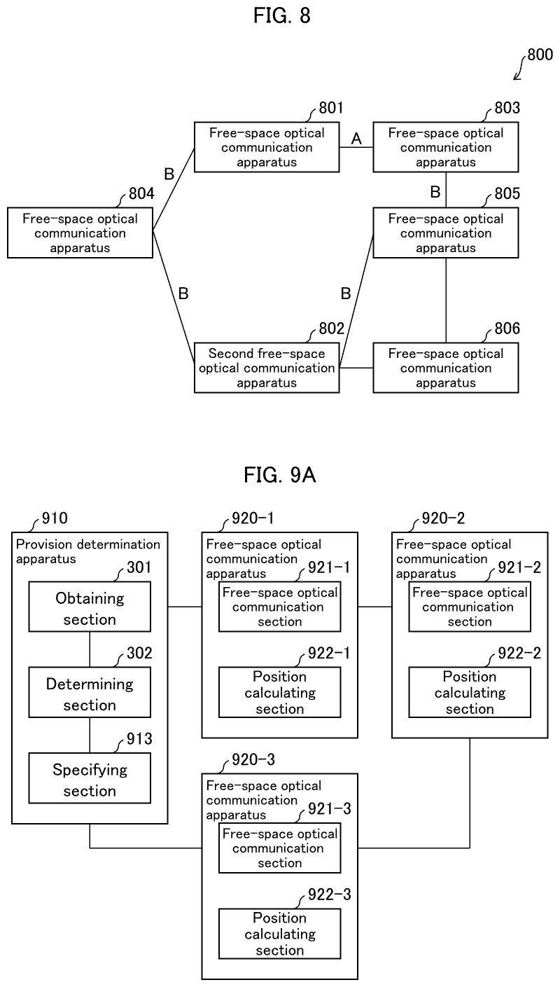

FIG. 8 shows an example of a free-space optical communication network 800. For example, in a case where a load relating to communication traffic between free-space optical communication apparatuses 801 and 803 (path A) is high, a free-space optical communication apparatus 804, which is connected to the free-space optical communication apparatus 801, a free-space optical communication apparatus 805, which is connected to the free-space optical communication apparatus 803, and a second free-space optical communication apparatus 802 may be connected to each other. Consequently, the communication traffic between the free-space optical communication apparatuses 801 and 803 can be distributed to a communication path (path B) between the free-space optical communication apparatus 804, the second free-space optical communication apparatus 802, and the free-space optical communication apparatus 805. Here, the free-space optical communication apparatus 801 or the free-space optical communication apparatus 803 may be the first free-space optical communication apparatus. For example, the specifying means 605 may specify, as a position where the second free-space optical communication apparatus 802 is to be provided, a place where a communicable range of the free-space optical communication apparatus 804 and a communicable range of the free-space optical communication apparatus 805 overlap each other. Here, the communicable range of the free-space optical communication apparatus may be defined as a range within a given distance from the free-space optical communication apparatus. The communicable range of the free-space optical communication apparatus may be input by a user of the provision determination system 600. The communicable range of the free-space optical communication apparatus may be determined by the specifying means on the basis of a map of the free-space optical communication network 800 of the provision determination system 600. Here, the map of the free-space optical communication network 800 may be a map into which a range where a free-space optical communication apparatus can be provided is input or a map into which an obstacle present in the place where the free-space optical communication network 800 is provided is input. Further, the specifying means may specify a plurality of positions where the second free-space optical communication apparatus 802 is to be provided.

[When Provision of Second Free-Space Optical Communication Apparatus is Determined to be Necessary Based on Load Relating to Communication Traffic in Plurality of Segments]

In a case where a load relating to communication traffic between the plurality of apparatuses is high, the specifying means 605 may specify the position where the second free-space optical communication apparatus is to be provided so that the communication between the plurality of free-space optical communication apparatuses is decentralized. For example, in a case where the load relating to the communication traffic between the free-space optical communication apparatuses 801 and 803 and the load relating to the communication traffic between the free-space optical communication apparatuses 803 and 805 are high, the free-space optical communication apparatus 804, the free-space optical communication apparatus 806, which is connected to the free-space optical communication apparatus 805, and the second free-space optical communication apparatus 802 may be connected to each other. This can decentralize the load relating to the communication traffic between the free-space optical communication apparatuses 801 and 803 and the load relating to the communication traffic between the free-space optical communication apparatuses 803 and 805. For example, the specifying means 605 may specify, as the position where the second free-space optical communication apparatus 802 is to be provided, a place where the communicable range of the free-space optical communication apparatus 804 and a communicable range of the free-space optical communication apparatus 806 overlap each other. As discussed above, in a case where the load relating to the communication traffic is high, the specifying means 605 may specify the position where the second free-space optical communication apparatus is to be provided so that a new communication path is formed, the new communication path connecting free-space optical communication apparatuses at respective ends of a segment having the high load. Further, the specifying means 605 may specify the place where the second free-space optical communication apparatus is to be provided so that a new communication path is formed, the new communication path connecting free-space optical communication apparatuses at respective ends of a longer segment including the segment having in which the load relating to the communication is high.

In a case where a load relating to a CPU of a single free-space optical communication apparatus is high, the specifying means 605 may specify, as the position where the second free-space optical communication apparatus is to be provided, a place surrounding the free-space optical communication apparatus which is high in load relating to the CPU, for example. By providing the second free-space optical communication apparatus in the space surrounding the first free-space optical communication apparatus, it is possible to share part of or the whole of the free-space optical communication of the first free-space optical communication apparatus with the second free-space optical communication apparatus. Further, assuming that a load of communication traffic relating to a segment including the free-space optical communication apparatus which is high in load relating to the CPU is high, the specifying means 605 may specify the position where the second free-space optical communication apparatus is to be provided so that a new communication path is formed, the new communication path connecting free-space optical communication apparatuses at respective ends of a segment longer than the segment including the free-space optical communication apparatus having the high load relating to the CPU.

Further, in a case where loads relating to CPUs of the plurality of free-space optical communication apparatuses are high, the specifying means 605 may specify the position where the second free-space optical communication apparatus is to be provided so that a new communication path is formed, the new communication path connecting free-space optical communication apparatuses at respective ends of a segment longer than a segment(s) including the plurality of free-space optical communication apparatuses which are high in load relating to the CPU. The position where the second free-space optical communication apparatus is to be placed may be specified in a similar manner to the foregoing case where provision of the second free-space optical communication apparatus is determined to be necessary in accordance with the loads relating to communication traffic of the plurality of segments. Further, in a case where the free-space optical communication apparatuses which are high in load relating to the CPU are not provided in a consecutive manner, the position where the second free-space optical communication apparatus is to be provided may be specified for each of the free-space optical communication apparatuses which are high in load relating to the CPU in a similar manner to the foregoing case where the load relating to the CPU of the single free-space optical communication apparatus is high.

The following description will discuss a provision determination method in accordance with the fourth example embodiment. The provision determination method in accordance with the fourth example embodiment includes, in addition to the features of the provision determination methods in accordance with the first, second, and third example embodiments, the step of: specifying the position where the second free-space optical communication apparatus is to be provided, the specifying being carried out in accordance with (i) a result of the determination on the necessity, (ii) the pieces of information indicating the loads of the communication of the respective plurality of free-space optical communication apparatuses including the first free-space optical communication apparatus, and (iii) the pieces of position information of the respective plurality of free-space optical communication apparatuses.

(Setting Determination Apparatus)

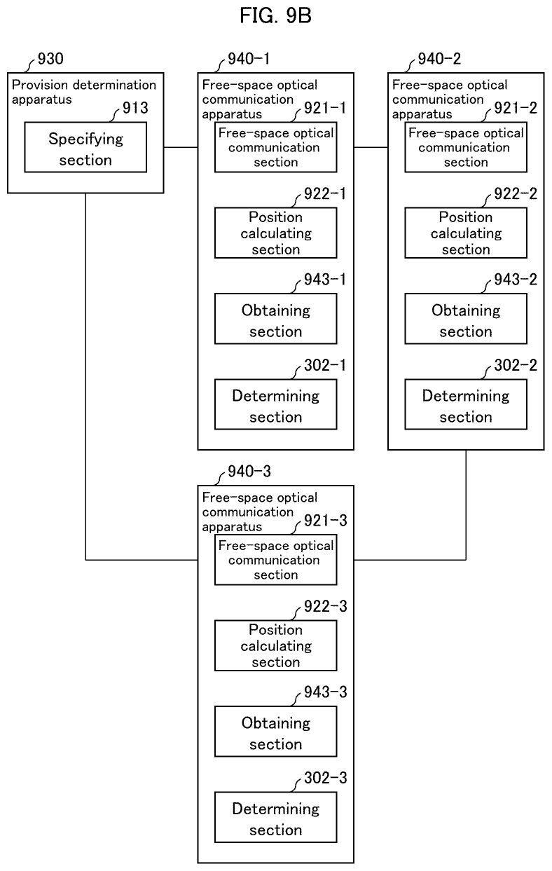

FIG. 9A is a block diagram illustrating an example of a configuration of a provision determination apparatus 910 in accordance with the fourth example embodiment of the present invention. Note that configurations identical to those of the first example embodiment are given identical reference signs, and a description thereof will be omitted. An obtaining section 301, a determining section 302, and a specifying section 913 may be a computer apparatus including a processor executing a program stored in a memory to execute a process. Hereinafter, in a case where free-space optical communication apparatuses 920-1, 920-2, and 920-3 are not distinguished from each other, the free-space optical communication apparatuses 920-1, 920-2, and 920-3 will be referred to as a free-space optical communication apparatus 920.

The following description will discuss an example of a method in which the obtaining section 301 obtains position information from the free-space optical communication apparatus 920. FIG. 9A shows an example in which constituent elements of the provision determination system in accordance with the fourth example embodiment are mounted in the provision determination apparatus 910. Here, the provision determination apparatus 910 is communicably connected to the free-space optical communication apparatuses 920-1 and 920-3.

The free-space optical communication apparatuses 920 communicate with each other over free-space optical communication via free-space optical communication sections 921. Each free-space optical communication section 921 emits light in a space. Then, if there is a response to the emitted light, the free-space optical communication section 921 determines that a free-space optical communication apparatus 920 which is a communication target exists in a direction in which the response is made, and carries out connection in the direction. The free-space optical communication section 921 may emit light including information relating to the direction in which the light is emitted.

A position calculating section 922 calculates a position of the free-space optical communication apparatus 920. For example, in accordance with the information relating to the direction in which the light is emitted or the direction of emission included in the light of the communication target, the position calculating section 922 calculates a relative positional relation between the free-space optical communication apparatus 920 including that position calculating section 922 and the free-space optical communication apparatus 920 which is the communication target. Alternatively, for example, the position calculating section 922 may (i) share, with another free-space optical communication apparatus 920, information relating to directions in which rays of light of two or more free-space optical communication apparatuses 920 are emitted and (ii) specify a relative positional relation between the free-space optical communication apparatus 920 including that position calculating section 922 and the another free-space optical communication apparatus 920 with which the information relating to the directions in which the rays of light are emitted is shared.

The obtaining section 301 obtains the position information of the free-space optical communication apparatus 920 calculated by the position calculating section 922. Here, the position information may include the relative positional relation between the free-space optical communication apparatuses 920. In a case where the obtaining section 301 obtains the relative positional relation, the specifying section 913 may specify the position of the another free-space optical communication apparatus 920 in accordance with information indicating an absolute position of at least one free-space optical communication apparatus 920. Further, the obtaining section 301 may obtain, from a free-space optical communication apparatus 920 which is communicably connected to the provision determination apparatus 910, position information of a free-space optical communication apparatus 920 which is not communicably connected to the provision determination apparatus 910. In the example shown in FIG. 9A, for example, the obtaining section 301 may obtain position information of the free-space optical communication apparatus 920-2 from the free-space optical communication apparatus 920-1 or the free-space optical communication apparatus 920-3.

FIG. 9B shows an example in which constituent elements of the provision determination system in accordance with the fourth example embodiment are mounted dispersedly in a provision determination apparatus 930 and a free-space optical communication apparatus 940. Note that configurations identical to those shown in FIG. 9B in accordance with the fourth example embodiment are given identical reference signs, and a description thereof will be omitted. An obtaining section 943 has the same function as the obtaining section 301, and is further configured to obtain position information of the free-space optical communication apparatus 940.

In the fourth example embodiment, the position where the second free-space optical communication apparatus is to be provided is specified. Specifying the position where the second free-space optical communication apparatus is to be provided enables, for example, an administrator of the free-space optical communication network to provide the second free-space optical communication apparatus in the position thus specified. Specifying the position where the second free-space optical communication apparatus is to be provided can reduce the burden on the administrator or the like of the free-space optical communication network, the burden relating to a work in which he/she considers the position where the second free-space optical communication apparatus is to be provided.

Further, in a case where the free-space optical communication apparatus is capable of calculating a position of the free-space optical communication apparatus as are the free-space optical communication apparatuses 920 and 940, the provision determination apparatuses 910 and 930, each of which includes the specifying section 913, may not retain pieces of position information of all the free-space optical communication apparatuses constituting the free-space optical communication network. Further, in the case where the free-space optical communication apparatus is capable of calculating the position of the free-space optical communication apparatus as are the free-space optical communication apparatuses 920 and 940, it is possible to reduce the labor of the administrator or the like for all the way manually inputting the position of the second free-space optical communication apparatus to the provision determination system 600, the provision determination apparatus 910, and the provision determination apparatus 930 when the second free-space optical communication apparatus is provided in the free-space optical communication network.

### Fifth Example Embodiment

A provision determination system 1000 in accordance with a fifth example embodiment differs from the provision determination system 600 in accordance with the fourth example embodiment in that the provision determination system 1000 further includes a map generating means 1006. Note that configurations identical to those of the fourth example embodiment are given identical reference signs, and a description thereof will be omitted. The provision determination system 1000 in accordance with the fifth example embodiment may also include the setting means 403 and the calculating means 504 explained in the second example embodiment and the third example embodiment.

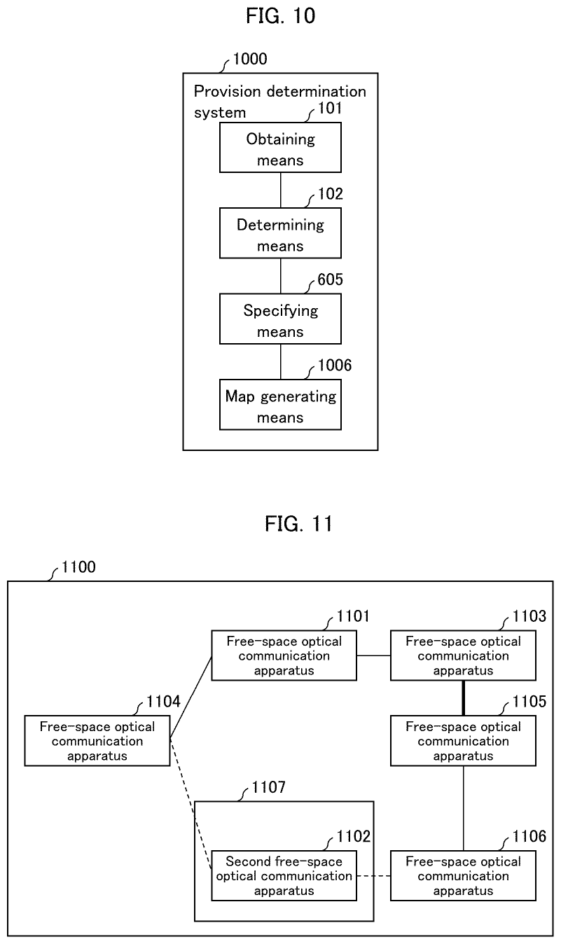

FIG. 10 is a block diagram illustrating an example of a configuration of the provision determination system 1000 in accordance with the fifth example embodiment of the present invention. The map generating means 1006 generates, in accordance with (i) pieces of information indicating loads relating to communication of a respective plurality of free-space optical communication apparatuses and (ii) pieces of position information of the respective plurality of free-space optical communication apparatuses, a map indicating the loads relating to the communication of the plurality of communication apparatuses and a specified position of a second free-space optical communication apparatus. For example, the map generating means generates a map indicating (i) the position, specified by the specifying means 605, where the second free-space optical communication apparatus is to be provided and (ii) the positions of the respective plurality of free-space optical communication apparatuses constituting the free-space optical communication network, in such a manner that the free-space optical communication apparatuses are indicated in different indication modes depending on the indices of the loads. A method for indicating the free-space optical communication apparatuses in different indication modes may be, for example, a method according to which a free-space optical communication apparatus for which provision of the second free-space optical communication apparatus is determined to be necessary and the other free-space optical communication apparatuses are indicated in different colors or a method according to which the free-space optical communication apparatus for which provision of the second free-space optical communication apparatus is determined to be necessary is indicated larger than the other free-space optical communication apparatuses. For example, in a case where provision of the second free-space optical communication apparatus is determined to be necessary in accordance with a load relating to communication traffic in a certain segment, the certain segment may be indicated in (i) a different color from the other segments or (ii) a line having a different thickness from the other segments. Further, the map generating means may indicate, by a dot or a range, a position where a second free-space optical communication apparatus 1102 is to be provided.

FIG. 11 is a view illustrating an example of a map 1100 generated by the map generating means 1006. In FIG. 11, the free-space optical communication apparatus 1105 is indicated larger than the other free-space optical communication apparatuses. Further, a line indicating a segment between the free-space optical communication apparatuses 1103 and 1105 is indicated thicker than lines indicating the other free-space optical communication apparatuses and the other segments. Here, it is determined that the free-space optical communication apparatus 1105 has a high communication load and thus needs provision of a second free-space optical communication apparatus. Further, also in accordance with a determination made in accordance with the load relating to communication traffic in the segment between the free-space optical communication apparatuses 1103 and 1105, it is determined that the free-space optical communication apparatus 1105 needs provision of the second free-space optical communication apparatus. FIG. 11 indicates a position where the second free-space optical communication apparatus 1102 is to be provided. In addition, the indication may include connection relations between (i) the second free-space optical communication apparatus 1102 and (ii) the free-space optical communication apparatuses around the second free-space optical communication apparatus 1102 in a case where the second free-space optical communication apparatus 1102 is provided. Further, the map 1100 may indicate a range for the position where the second free-space optical communication apparatus 1102 is to be provided. The map generating means may cause the map 1100 indicate the range for the position where the second free-space optical communication apparatus 1102 is to be provided. The range may be indicated by, for example, a candidate 1107 for the position where the second free-space optical communication apparatus is to be provided. Even in a case where provision of the second free-space optical communication apparatus is not determined to be necessary, the map generating means may indicate the free-space optical communication apparatuses and/or the segments between the free-space optical communication apparatuses in different modes depending on the loads of communication of the free-space optical communication apparatuses. For example, an apparatus for which provision of the second free-space optical communication apparatus is not determined to be necessary but which has a high communication load may be indicated in a different manner from the other free-space optical communication apparatuses.

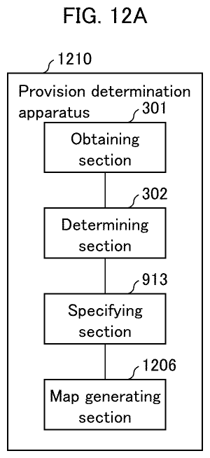

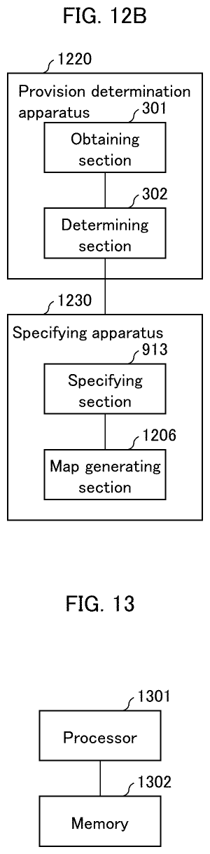

Each of FIGS. 12A and 12B is a block diagram illustrating an example of the provision determination apparatus in accordance with the fifth example embodiment. Note that configurations identical to those of the first to fourth example embodiments are given identical reference signs, and a description thereof will be omitted. A map generating section 1206 has the same function as the map generating means 1006. For example, according to a provision determination apparatus 1210 shown in FIG. 12A, constituent elements of the fifth example embodiment is mounted in a single apparatus. Alternatively, for example, as in a provision determination apparatus 1220 and a specifying apparatus 1230 shown in FIG. 12B, the constituent elements of the fifth example embodiment may be mounted in different apparatuses. The provision determination apparatus 1220 may include a free-space optical communication section 921 and a position calculating section 922. Note that the provision determination apparatuses 1210 and 1220 in accordance with the fifth example embodiment may also have the configurations having the same functions as the setting means 403 and the calculating means 504 described in the second and third example embodiments.

The provision determination system in accordance with the fifth example embodiment generates a map indicating (i) loads relating to communication of a respective plurality of communication apparatuses and (ii) a specified position of a second free-space optical communication apparatus. Forming the map enables, for example, an administrator of the free-space optical communication network to visually determine a position suitable for provision of a free-space optical communication apparatus. Further, forming the map enables, for example, the administrator of the free-space optical communication network to visually understand a status of the communication load of the free-space optical communication apparatus(es).

A provision determination method achieved by adding a setting method of the map generating means 1006 to the provision determination method in accordance with the fourth example embodiment is also within the scope of the disclosure of the fifth example embodiment. The provision determination method in accordance with the fifth example embodiment includes, in addition to the features of the provision determination method in accordance with the fourth example embodiment, the step of generating, in accordance with (i) the pieces of information indicating the loads relating to the communication of the respective plurality of free-space optical communication apparatuses and (ii) and the pieces of position information of the respective plurality of free-space optical communication apparatuses, a map indicating the loads of the communication of the respective plurality of free-space optical communication apparatuses and a specified position of the second free-space optical communication apparatus.

The present disclosure is not limited to the example embodiments above, but can be altered by a skilled person in the art. The present disclosure also encompasses, in its technical scope, any embodiment derived by combining configurations, operation, and processes disclosed in differing embodiments as appropriate.

The configurations in accordance with the first to fifth example embodiments may be configured by a single piece of hardware. The configurations in accordance with the first to fifth example embodiments may be configured by a single piece of software. The configurations in accordance with the first to fifth example embodiments may be configured by a plurality of pieces of hardware. The configurations in accordance with the first to fifth example embodiments may be configured by a plurality of pieces of software. The configurations in accordance with the first to fifth example embodiments may be configured by a combination of hardware and software. The functions in accordance with the first to fifth example embodiments may be implemented in a cloud. The apparatuses, functions, and processes may be realized by a computer including a processor 1301 and a memory 1302 such as those shown FIG. 13. For example, a program for carrying out the provision determination methods discussed in the first to fifth example embodiments may be stored in the memory 1302, and the program stored in the memory 1302 may be read and executed by the processor 1301, so that the functions described in the first to fifth example embodiments are realized.

When read by the computer, the program includes a group of instructions for causing the computer to execute one or more of the functions described in the first to fifth example embodiments. The program is stored in the memory 1302. Examples of the processor 1301 encompass a Central Processing Unit (CPU). Examples of the memory 1302 encompass a Read Only Memory (ROM), a Random Access Memory (RAM), a flash memory, and a Solid State Drive (SSD).

The present disclosure is not limited to the foregoing example embodiments. That is, the present invention may employ various aspects that a person skilled in the art can understand within the scope of the present disclosure. Some or all of the foregoing example embodiments can be described as below. Note, however, that the present invention is not limited to the example aspects described below.

[Supplementary Note 1]

A provision determination system including: an obtaining means that obtains information indicating a load of communication of a first free-space optical communication apparatus connected to a free-space optical communication network; and a determining means that makes a determination on necessity for provision of a second free-space optical communication apparatus connected to the free-space optical communication network, the determination being made in accordance with the information indicating the load of the communication.

[Supplementary Note 2]

The provision determination system described in Supplementary Note 1, further including a setting means that sets a threshold in accordance with performance of the first free-space optical communication apparatus, wherein the determining means makes the determination on the necessity for provision of the second free-space optical communication apparatus such that the determination is made in accordance with the information indicating the load of the communication and the threshold.

[Supplementary Note 3]

The provision determination system described in Supplementary Note 2, further including a calculating means that calculates indices of loads in respective time slots in accordance with the information indicating the load of the communication of the first free-space optical communication apparatus, wherein, in accordance with the indices of the loads in the respective time slots and the threshold, the determining means makes the determination on the necessity for provision of the second free-space optical communication apparatus.

[Supplementary Note 4]

The provision determination system described in any one of Supplementary Notes 1 to 3, further including: a specifying means that specifies a position where the second free-space optical communication apparatus is to be provided, the specifying being carried out in accordance with (i) a result of the determination on the necessity, (ii) pieces of information indicating loads of communication of a respective plurality of free-space optical communication apparatuses including the first free-space optical communication apparatus, and (iii) pieces of position information of the respective plurality of free-space optical communication apparatuses.

[Supplementary Note 5]

The provision determination system described in Supplementary Note 4, further including: a map generating means that generates, in accordance with (i) the pieces of information indicating the loads of the communication of the respective plurality of free-space optical communication apparatuses and (ii) the pieces of position information of the respective plurality of free-space optical communication apparatuses, a map indicating the loads of the communication of the respective plurality of free-space optical communication apparatuses and the specified position of the second free-space optical communication apparatus.

[Supplementary Note 6]

A provision determination apparatus including: an obtaining section that obtains information indicating a load of communication of a first free-space optical communication apparatus connected to a free-space optical communication network; and a determining section that makes a determination on necessity for provision of a second free-space optical communication apparatus connected to the free-space optical communication network, the determination being carried out in accordance with the information indicating the load of the communication.

[Supplementary Note 7]

The provision determination apparatus described in Supplementary Note 6, further including: a setting section that sets a threshold in accordance with performance of the first free-space optical communication apparatus, wherein the determining section makes the determination on the necessity for provision of the second free-space optical communication apparatus such that the determination is made in accordance with the information indicating the load of the communication and the threshold.

[Supplementary Note 8]

The provision determination apparatus described in Supplementary Note 7, further including a calculating section that calculates indices of loads in respective time slots in accordance with the information indicating the load of the communication of the first free-space optical communication apparatus, wherein the determining section makes the determination on the necessity for provision of the second free-space optical communication apparatus such that the determination is made in accordance with the indices of the loads in the respective time slots and the threshold.

[Supplementary Note 9]

The provision determination apparatus described in any one of Supplementary Notes 6 to 8, wherein: the obtaining section obtains pieces of information indicating loads of communication of a respective plurality of free-space optical communication apparatuses including the first free-space optical communication apparatus and pieces of position information of the respective plurality of free-space optical communication apparatuses; and the provision determination apparatus further includes a specifying section that specifies a position where the second free-space optical communication apparatus is to be provided, the specifying being carried out in accordance with (i) a result of the determination on the necessity, (ii) the pieces of information indicating the loads of the communication of the respective plurality of free-space optical communication apparatuses, and (iii) the pieces of position information of the respective plurality of free-space optical communication apparatuses.

[Supplementary Note 10]

The provision determination apparatus described in Supplementary Note 9, further including: a map generating section that generates, in accordance with (i) the pieces of information indicating the loads of the communication of the respective plurality of free-space optical communication apparatuses and (ii) the pieces of position information of the respective plurality of free-space optical communication apparatuses, a map indicating the loads of the communication of the respective plurality of free-space optical communication apparatuses and the specified position of the second free-space optical communication apparatus.

[Supplementary Note 11]

A provision determination method including the steps of: obtaining information indicating a load of communication of a first free-space optical communication apparatus connected to a free-space optical communication network; and, in accordance with the information indicating the load of the communication, making a determination on necessity for provision of a second free-space optical communication apparatus connected to the free-space optical communication network.

[Supplementary Note 12]

The provision determination method described in Supplementary Note 11, further including the step of: setting a threshold in accordance with performance of the first free-space optical communication apparatus, wherein, in the step of determining, the determination on the necessity for provision of the second free-space optical communication apparatus is made in accordance with the information indicating the load of the communication and the threshold.

[Supplementary Note 13]

The provision determination method described in Supplementary Note 12, further including the step of: calculating indices of loads in respective time slots in accordance with the information indicating the load of the communication of the first free-space optical communication apparatus, wherein, in the step of determining, the determination on the necessity for provision of the second free-space optical communication apparatus is made in accordance with the indices of the loads in the respective time slots and the threshold.

[Supplementary Note 14]

The provision determination method described in any one of Supplementary Notes 11 to 13, further including the step of: specifying a position where the second free-space optical communication apparatus is to be provided, the specifying being carried out in accordance with (i) a result of the determination on the necessity, (ii) pieces of information indicating loads of communication of a respective plurality of free-space optical communication apparatuses including the first free-space optical communication apparatus, and (iii) pieces of position information of the plurality of free-space optical communication apparatuses.

[Supplementary Note 15]

The provision determination method described in Supplementary Note 14, further including the step of: generating, in accordance with (i) the pieces of information indicating the loads of the communication of the respective plurality of free-space optical communication apparatuses and (ii) the pieces of position information of the respective plurality of free-space optical communication apparatuses, a map indicating the loads of the communication of the respective plurality of free-space optical communication apparatuses and the specified position of the second free-space optical communication apparatus.

### REFERENCE SIGNS LIST

100: provision determination system
101: obtaining means
102: determining means
300: provision determination apparatus
301: obtaining section
302: determining section
400: provision determination system
403: setting means
500: provision determination system
504: calculating means
600: provision determination system
605: specifying means
800: free-space optical communication network
801: free-space optical communication apparatus
802: second free-space optical communication apparatus
803: free-space optical communication apparatus
804: free-space optical communication apparatus
805: free-space optical communication apparatus
910: provision determination apparatus
913: specifying section
920: free-space optical communication apparatus
921: free-space optical communication section
922: position calculating section
930: provision determination apparatus
940: free-space optical communication apparatus
943: obtaining section
1000: provision determination system
1006: map generating means
1100: map
1101: free-space optical communication apparatus
1102: second free-space optical communication apparatus
1103: free-space optical communication apparatus
1104: free-space optical communication apparatus
1105: free-space optical communication apparatus
1106: free-space optical communication apparatus
1107: candidate for position where second free-space optical communication apparatus is to be provided
1210: provision determination apparatus
1206: map generating section
1220: provision determination apparatus
1230: specifying apparatus
1301: processor
1302: memory

1. A provision determination system comprising at least one processor,
the at least one processor executing:
an obtaining process of obtaining information indicating a load of communication of a first free-space optical communication apparatus connected to a free-space optical communication network; and
a determining process of making a determination on necessity for provision of a second free-space optical communication apparatus connected to the free-space optical communication network, the determination being made in accordance with the information indicating the load of the communication.

2. The provision determination system according to claim 1, wherein:
the at least one processor executes a setting process of setting a threshold in accordance with performance of the first free-space optical communication apparatus, and
in the determining process, the at least one processor makes the determination on the necessity for provision of the second free-space optical communication apparatus such that the determination is made in accordance with the information indicating the load of the communication and the threshold.

3. The provision determination system according to claim 2, wherein:
the at least one processor executes a calculating process of calculating indices of loads in respective time slots in accordance with the information indicating the load of the communication of the first free-space optical communication apparatus, and
in the determining process, the at least one processor makes the determination on the necessity for provision of the second free-space optical communication apparatus such that the determination is made in accordance with the indices of the loads in the respective time slots and the threshold.

4. The provision determination system according to claim 1, wherein:
the at least one processor executes a specifying process of specifying a position where the second free-space optical communication apparatus is to be provided, the specifying being carried out in accordance with (i) a result of the determination on the necessity, (ii) pieces of information indicating loads of communication of a respective plurality of free-space optical communication apparatuses including the first free-space optical communication apparatus, and (iii) pieces of position information of the respective plurality of free-space optical communication apparatuses.

5. The provision determination system according to claim 4, wherein:
the at least one processor executes a map generating process of generating, in accordance with (i) the pieces of information indicating the loads of the communication of the respective plurality of free-space optical communication apparatuses and (ii) the pieces of position information of the respective plurality of free-space optical communication apparatuses, a map indicating the loads of the communication of the respective plurality of free-space optical communication apparatuses and the specified position of the second free-space optical communication apparatus.

6. A provision determination apparatus comprising at least one processor,
the at least one processor executing:
an obtaining process of obtaining information indicating a load of communication of a first free-space optical communication apparatus connected to a free-space optical communication network; and
a determining process of making, in accordance with the information indicating the load of the communication, a determination on necessity for provision of a second free-space optical communication apparatus connected to the free-space optical communication network.

7. The provision determination apparatus according to claim 6, wherein:
the at least one processor executes a setting process of setting a threshold in accordance with performance of the first free-space optical communication apparatus, and
in the determining process, the at least one processor makes the determination on the necessity for provision of the second free-space optical communication apparatus such that the determination is made in accordance with the information indicating the load of the communication and the threshold.

8. The provision determination apparatus according to claim 7, wherein:
the at least one processor executes a calculating process of calculating indices of loads in respective time slots in accordance with the information indicating the load of the communication of the first free-space optical communication apparatus, and
in the determining process, the at least one processor makes the determination on the necessity for provision of the second free-space optical communication apparatus such that the determination is made in accordance with the indices of the loads in the respective time slots and the threshold.

9. The provision determination apparatus according to claim 6, wherein:
the at least one processor executes a specifying process of specifying a position where the second free-space optical communication apparatus is to be provided, the specifying being carried out in accordance with (i) a result of the determination on the necessity, (ii) pieces of information indicating loads of communication of a respective plurality of free-space optical communication apparatuses including the first free-space optical communication apparatus, and (iii) pieces of position information of the plurality of free-space optical communication apparatuses.

10. The provision determination apparatus according to claim 9, wherein:
the at least one processor executes a map generating process of generating, in accordance with (i) the pieces of information indicating the loads of the communication of the respective plurality of free-space optical communication apparatuses and (ii) the pieces of position information of the respective plurality of free-space optical communication apparatuses, a map indicating the loads of the communication of the respective plurality of free-space optical communication apparatuses and the specified position of the second free-space optical communication apparatus.

11. A provision determination method comprising the steps of:
obtaining information indicating a load of communication of a first free-space optical communication apparatus connected to a free-space optical communication network; and
in accordance with the information indicating the load of the communication, making a determination on necessity for provision of a second free-space optical communication apparatus connected to the free-space optical communication network.

12. The provision determination method according to claim 11, further comprising the step of:
setting a threshold in accordance with performance of the first free-space optical communication apparatus, wherein
in the step of determining, the determination on the necessity for provision of the second free-space optical communication apparatus is made in accordance with the information indicating the load of the communication and the threshold.

13. The provision determination method according to claim 12, further comprising the step of:
calculating indices of loads in respective time slots in accordance with the information indicating the load of the communication of the first free-space optical communication apparatus, wherein
in the step of determining, the determination on the necessity for provision of the second free-space optical communication apparatus is made in accordance with the indices of the loads in the respective time slots and the threshold.

14. The provision determination method according to claim 11, further comprising the step of:
specifying a position where the second free-space optical communication apparatus is to be provided, the specifying being carried out in accordance with (i) a result of the determination on the necessity, (ii) pieces of information indicating loads of communication of a respective plurality of free-space optical communication apparatuses including the first free-space optical communication apparatus, and (iii) pieces of position information of the plurality of free-space optical communication apparatuses.

15. The provision determination method according to claim 14, further comprising the step of:
generating, in accordance with (i) the pieces of information indicating the loads of the communication of the respective plurality of free-space optical communication apparatuses and (ii) the pieces of position information of the respective plurality of free-space optical communication apparatuses, a map indicating the loads of the communication of the respective plurality of free-space optical communication apparatuses and the specified position of the second free-space optical communication apparatus.
